(19) United States
(12) Patent Application Publication
(10) Pub. No.: US 2010/0293109 A1
(43) Pub. Date: Nov. 18, 2010

(54) Systems, Methods and Computer Program Products For Routing Electronic Trade Orders For Execution

(75) Inventors: Rajendra Jain, Princeton, NJ (US); Hitesh Mittal, Edison, NY (US)

Correspondence Address: ROTHWELL, FIGG, ERNST & MANBECK, P.C., 1425 K STREET, N.W., SUITE 800, WASHINGTON, DC, 20005, US

(73) Assignee: ITG SOFTWARE SOLUTIONS, INC., Culver City, CA (US)

(21) Appl. No.: 12/780,681

(22) Filed: May 14, 2010

Related U.S. Application Data
(60) Provisional application No. 61/178,804, filed on May 15, 2009.

(51) Int. Cl. G06Q 40/00

(52) U.S. Cl. 705/36 R; 705/37

(57) ABSTRACT

A system, method and computer program product are provided for routing electronic trade orders to trade execution venues. At an electronic trading server, electronic order information is received that defines a first electronic trade order including an identification of underlying assets to be traded on an electronic exchange or marketplace, a side of the trade, and a limit price. The electronic order information is stored in an electronic data storage facility. One or more second electronic trade orders are generated from the first electronic trade order and transmitted, via a trade router, to one or more electronic trading venues. Market data for a non-displayed electronic trading venue is received. It is determined if one or more of the second electronic trade orders has become stagnant. If any of orders are determined to be stagnant, the stagnant orders are cancelled and one or more third electronic trade orders are generated based on the first electronic trade order and on the cancelled orders, and transmitted to the non-displayed electronic trading venue.

### CROSS-REFERENCE TO RELATED APPLICATIONS

This application claims the benefit of priority to U.S. Provisional Application Ser. No. 61/178,804, entitled “SYSTEMS, METHODS AND COMPUTER PROGRAM PRODUCTS FOR ROUTING ELECTRONIC TRADE ORDERS FOR EXECUTION” filed on May 15, 2009, the entire contents of which are incorporated herein by reference.

### BACKGROUND OF THE INVENTION

1. Field of the Invention

This invention relates generally to financial trading. More particularly, the invention relates to systems and methods for routing electronic orders to buy or sell tradeable securities and commodities to electronic trading venues for execution.

2. Background of the Related Art

Managers of portfolios of assets, such as securities, seek to maximize the value of their portfolios by buying and selling assets therein. Investors seek to reduce traditional trading costs and opportunity costs as well when trading their assets. Managers often rebalance their portfolios in response to a number of indicators and analyses.

Assets can be traded electronically through a number of different trade execution venues (e.g., NYSE, NASDAQ, POSIT, etc.) having a variety of different liquidity characteristics. Currently, financial systems exist that assist traders with routing, i.e., directing, their securities transactions to favorable trading venues. These systems may be generically known in the industry as “smart routers.”

Smart routers provide consolidated market access that aggressively scans a number of connected trade execution venues while attempting to find the best possible liquidity sources. Through consistent use of the best possible liquidity sources, trades achieve the benefit of decreased costs and significant price improvement.

Traders may also use algorithmic trading systems that utilize models and strategies to provide traders the best possible execution price while trying to reduce market impact. Institutional traders, i.e., traders who execute large volume orders, often employ algorithmic trading systems to slice and dice large block orders into smaller, more executable, orders that may be transacted throughout a trading day or even over a longer period. Algorithmic trading systems can be coupled with smart routers.

Current smart routing systems suffer from problems with finding liquidity for all order sources. For example, smart routers can receive orders to trade securities from indirect sources, such as algorithmic trading systems. However, when receiving an order from an algorithmic trading system, the smart routers do not have access to data submitted in the trader's original algorithmic trade order, e.g., an original limit price. Also, current smart routing systems fail to recognize when placed orders have become stagnant, and thus also fail to take additional steps to ensure that the orders are executed in a different trade execution venue.

Thus, there is a need in the field for a routing system that intuits when an order remains stagnant and compensates to execute the order at a price acceptable to the trader. Further, there is a need for a router that recognizes when a limit order will not execute at the prevailing market conditions, determines if the limit order has play, i.e., room to be adjusted, and adjusts the limit order so that it will execute in the same or a different trading venue.

### SUMMARY OF THE INVENTION

In one embodiment of the current invention, a computerized method for smart order routing is provided. The method is performed by receiving at a server, electronic information defining a limit order to trade assets on an electronic exchange or marketplace. This electronic information is stored, by the server, in an electronic data storage facility and comprises, for the assets of the limit order to trade, information identifying: security name, symbol, or identifier, transaction side, total quantity to be traded, and limit price. Next, a router limit order is generated at a router. The router limit order is based on at least the information identifying the assets and the prevailing market conditions. The router limit order is transmitted by the router to a trading venue. The router then determines if the router limit order is stagnant. If the router limit order is stagnant, the router checks for liquidity at a dark trading venue, such as an ATS. If there is liquidity at the ATS, the placed router limit order is cancelled, and an ATS order is generated. The ATS order is based on, at least, the information identifying the assets and prevailing ATS conditions. Finally, the new ATS order is transmitted by the router to the ATS.

In another embodiment of the current invention, a computerized method for smart order routing is provided. The method is performed by receiving, by an electronic trading server, electronic order information that defines a first electronic trade order. The electronic information includes an identification of assets to trade on an electronic exchange or marketplace, the side of the first electronic trade order, and at least one limit price for the first electronic trade order. This electronic trade information is stored, by the electronic trading server, in an electronic data storage facility. According to a trading strategy, the electronic trading server generates one or more second electronic trade orders from the first electronic trade order, and transmits, via an electronic trade router, the one or more second electronic trade orders to one or more electronic trading venues. The electronic trading server receives market data from a non-displayed electronic trading venue. The electronic trading server determines if one or more of the second electronic trade orders has become stagnant. If any of the second electronic trade orders are determined to be stagnant, they are electronically cancelled, and one or more third electronic trade orders are generated based on the first electronic trade order and on the cancelled orders. These third electronic trade orders are then transmitted to the non-displayed electronic trading venue.

In another embodiment of the current invention, a system for smart order routing is provided. The system includes an electronic trading server. The electronic trading server is configured to receive electronic order information defining an first electronic trade order; to store the electronic order information in an electronic data storage facility; to generate, according to a trading strategy, one or more second electronic trade orders from the first electronic trade order; to transmit, via an electronic trade router, the one or more second electronic trade orders to one or more electronic trading venues; and to receive market data from a non-displayed electronic trading venue. The stored electronic order information includes an identification of assets to trade on an electronic exchange or marketplace, the side of the first electronic trade order, and at least one limit price for the first electronic trade order. The electronic trading server is further configured to determine if one or more of the second electronic trade orders has become stagnant; and if any of the second electronic trade orders are determined to be stagnant, to electronically cancel the second electronic trade orders that were determined to be stagnant, to generate one or more third electronic trade orders based on the first electronic trade order and on the cancelled orders, and to transmit the third electronic trade orders to the non-displayed electronic trading venue.

In another embodiment of the present invention, a computer recordable medium having executable computer instructions stored thereon for smart order routing is provided. The computer instructions include the operations for performing smart order routing by receiving, by an electronic trading server, electronic order information that defines an first electronic trade order. The electronic information includes an identification of assets to trade on an electronic exchange or marketplace, the side of the first electronic trade order, and at least one limit price for the first electronic trade order. This electronic trade information is stored, by the electronic trading server, in an electronic data storage facility. According to a trading strategy, the electronic trading server generates one or more second electronic trade orders from the first electronic trade order, and transmits, via an electronic trade router, the one or more second electronic trade orders to one or more electronic trading venues. The electronic trading server receives market data from a non-displayed electronic trading venue. The electronic trading server determines if one or more of the second electronic trade orders has become stagnant. If any of the second electronic trade orders are determined to be stagnant, they are electronically cancelled, and one or more third electronic trade orders are generated based on the first electronic trade order and on the cancelled orders. These third electronic trade orders are then transmitted to the non-displayed electronic trading venue.

In one embodiment of the present invention, the above described process may be performed iteratively until the entire limit order is executed, or until the trader ends the process.

### BRIEF DESCRIPTION OF THE DRAWINGS

FIG. 1 is a block diagram of an exemplary trading system according to aspects of the present invention.

FIG. 2 is a block diagram of an exemplary electronic trade order router system.

FIG. 3 is a flow diagram of an exemplary routing process, according to the present invention.

FIG. 4 is a block diagram of an exemplary electronic trade order router system.

### DETAILED DESCRIPTION OF THE INVENTION

The current invention is applicable to electronic orders to buy or sell tradeable securities and commodities. Further, the current invention can be used with any electronic order to buy, sell, or otherwise transfer any type of tradeable asset. Thus, one of ordinary skill in the art would recognize that while tradeable securities and commodities are discussed herein, the teachings of the invention are generally applicable to all electronically tradeable assets.

ITG Software Solutions, Inc. (ITG), the assignee of the current application, has developed several smart routers, each having different characteristics. For example, SMART ROUTER provides a single destination for routing multiple assets and order types, i.e., market, limit, volume weighted average price (VWAP), etc. SMART ROUTER automatically searches all accessible execution venues, including displayed and non-displayed markets and connected electronic communication networks (ECN), for the best possible prices at which to execute securities transactions. SMART ROUTER offers flexibility by providing options as to price and size discretion and after-hours matching.

SMART MULTI-ROUTER includes the features of SMART ROUTER, and additionally includes the option to intelligently manage simultaneous presences in multiple execution venues using multi-posting functionality.

SMART HIDDEN ROUTER includes the features of SMART MULTI-ROUTER, but only posts hidden order types in multiple public markets and also searches alternative trading systems (ATS), e.g., ITG's POSIT Match and POSIT Now, for liquidity.

BLOCK ROUTER executes large orders with minimal price impact by seeking out larger pockets of liquidity and avoiding repetitive small-sized trades. By avoiding repetitive small-sized trades, traders can avoid sending signals of intent. BLOCK ROUTER tries to seek out large pockets of hidden liquidity.

BLOCK ATS ROUTER includes the features of BLOCK ROUTER, but additionally seeks out “dark” ATS liquidity. BLOCK ATS ROUTER provides consolidated access to ATS liquidity and public markets with one order type.

Smart routers can provide better execution prices by identifying the best sources of liquidity based on prevailing market conditions for a specific order. However, smart routers may receive electronic trade orders indirectly from algorithmic trading systems. Thus, it is possible that a smart router may receive an electronic trade order from a source, such as an algorithmic trading system, evaluate the prevailing market conditions, and, regardless of the original market or limit order provided, route the limit order to a trade venue that is based on the prevailing market conditions. Thus, a limit order routed by a smart router may have different limits than the original electronic trade order that it was based upon. While this duel limit order system generally results in execution of the order at a positive price point, there are situations that result in stagnation, e.g., no execution of a trade order, thereby increasing trade costs.

For example, a trader might provide an algorithmic trade order to BUY 100,000 shares of IBM at a limit price of $50.00 a share to an algorithmic trading system executing, for example, a VWAP trade strategy algorithm. Co-owned U.S. Pat. No. 7,613,647, titled System and Method for Executing Strategy Security Trading, and filed on Oct. 31, 2000, includes a detailed discussion of certain algorithmic trading systems, the entire contents of which are hereby incorporated herein by reference.

The algorithmic trading system may generate a plurality of electronic trade orders at different times and at different prices, according to the VWAP trading strategy algorithm, to fill the 100,000 share order for IBM. One such order may be a limit order to BUY 5,000 shares of IBM at a price of $49.50 or less. Smart router could receive this limit order from the algorithmic trading system and subsequently route the order to a trade execution venue, in this example the New York Stock Exchange (NYSE). However, the market conditions at the NYSE may have changed such that the best bid price, the price a buyer is willing to pay, is $49.60 and the offer price, the price a seller is willing to sell at, is $49.90. Thus, the order sent to the NYSE with a limit price of $49.50 will not execute because it is below the prevailing bid and offer prices, $49.60 and $49.90, respectively. Opportunity costs increase as a result because the electronic trade order was originally place with a limit price of $50.00 or less and could have executed at $49.90 per share.

The present invention attempts to solve, inter alia, the above described problem.

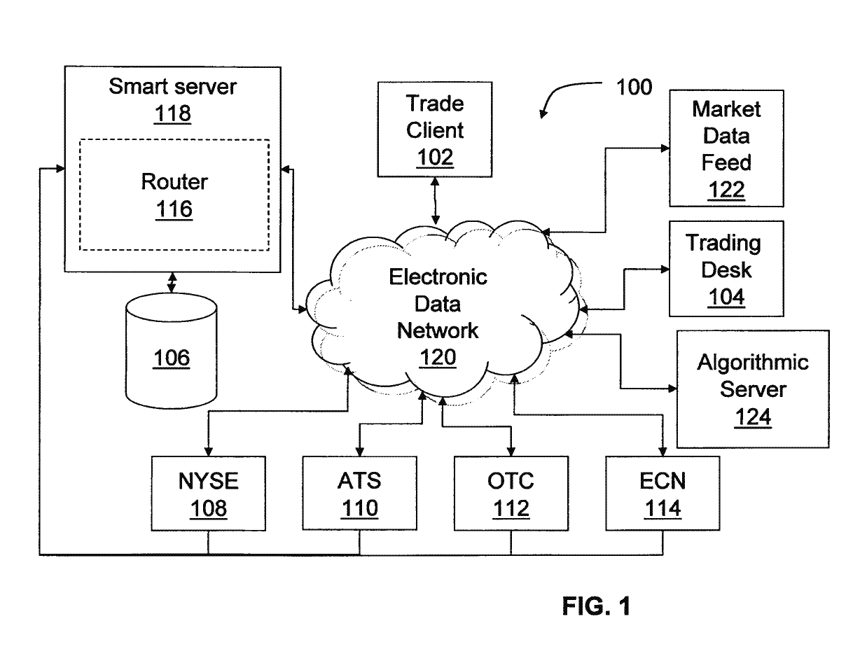

FIG. 1 is a simplified block diagram of an exemplary trading system according to an embodiment of the present invention. Referring to FIG. 1, system 100 may include a plurality of trading devices coupled with an electronic data network 120. For example, trade client 102 might include a networked computer configured to communicate desired trades or electronic trade orders to various destinations, such as to smart server 118 and ultimately to various trade venues (108, 110, 112, 114). Additionally, trade client 102 may be configured to communicate with an algorithmic trade system, shown as algorithmic server 124. Trading desk 104 might be associated, for example, with a buy-side trading desk at a buy-side trading firm or a sell-side trading desk at a sell-side trading firm, and may include one or more trading systems coupled with electronic data network 120 to execute or communicate with various trade desk programs, such as, order management systems (OMS), execution management systems (EMS), algorithmic trading systems (algorithmic server 124), and trade analytics systems. These systems may be used to connect electronically to trade venues, such as the NYSE 108, alternative trading systems (ATSs) 110, over-the-counter (OTC) venues 112 (including, but not limited to, NASDAQ), or electronic communications networks (ECNs) 114. The aforementioned list of trade venues is not all encompassing, and in no way limits the range of trade venues that the current invention might integrate or communicate with.

The electronic data network 120 may include public or private networks, electronic data networks, packets networks, wireless or other communication services, etc. In one embodiment of the present invention, the electronic data network 120 might include the Internet and/or a local area network.

A smart server 118 may be coupled with the electronic data network 120 and may be configured to receive electronic trade orders (e.g., via the Financial Information Exchange Protocol (FIX)) and to perform smart order routing via a contained router 116, as already described above and in further detail below.

While FIG. 1 shows the router 116 housed on smart server 118, it is contemplated that the router 116 could be contained in or communicate with multiple servers.

The smart server 118 may be configured to directly access various electronic trading venues (108, 110, 112, 114) through the electronic data network 120, or through a dedicated connection. Additionally, smart server 118 may be configured to receive market data, e.g., live quote data, historical data, etc.) from market data feed 122. The market data feed 122 is configured to communicate, among other things, quote information regarding the prevailing conditions in the market. The market data feed 122 is configured to provide quote information from a variety of trade venues including, but not limited to, public trading venues, ATSs, and other dark pools of liquidity. While one market data feed 122 is shown in FIG. 1, the current invention contemplates the use of multiple market data feeds. Smart server 118 may also be electronically coupled with a data storage facility or database 106. The database 106 may be housed on smart server 118 or on a separate computer, i.e., a database server. The database 106 may be a relational database, such as Oracle; however, other known database configurations are contemplated.

The database 106 may be configured to store information regarding prevailing market conditions that is received from the various electronic trading venues (108, 110, 112, 114) and/or the market data feed 122. Additionally, the database 106 may be used to store information regarding electronic trade orders received by or placed by the router 116 housed on the smart server 118.

Algorithmic server 124 is electronically coupled to the electronic data network 120 and may be configured to receive, among other things, algorithmic trade orders from trade client 102 or trading desk 104, electronically, and to implement the order via a trading strategy algorithm. Additionally, the algorithmic server 124 may be configured to communicate electronic trade orders to the smart server 118 and the electronic trading venues (108, 110, 112, 114), via the electronic data network 120 or through a dedicated connection.

If a limit order is received by the smart server 118 from the algorithmic server 124, preferably, the original information regarding the electronic trade order sent to the algorithmic server 124, including, but not limited to, the original price (e.g., an original limit price), is received and stored by smart server 118. The electronic trade order information may include security name/symbol/identifier, transaction side, total quantity to be traded, and limit price.

One skilled in the art will understand that multiple servers may be provided on the electronic data network 120, with each server running a variety of applications, which may include one or more router programs. Likewise, these additional servers may have access to various electronic trading venues (108, 110, 112, 114).

According to one aspect of the invention, a trader may electronically submit as electronic trade order, via computer client 102 or trade desk 104, to algorithmic server 124 for execution. Algorithmic server 124, as described above, may be configured to execute the electronic trade order by dividing the electronic trade order into one or more limit orders, according to the electronic trade order and a trader's overall trading strategy (e.g., VWAP). The one or more limit orders may then be transmitted to various destinations including the smart server 118 for routing, via router 116, to electronic trading venues (108, 112, 114), i.e., displayed markets and ECNs, for execution.

Once the one or more limit orders have been routed to and placed at the electronic trading venues (108, 112, 114), router 116 periodically (i.e., from time to time, continuously, or at an interval in between) determines if any of the limit orders are stagnant. A limit order may be deemed stagnant if the amount of time the limit order has gone unexecuted exceeds previously selected or determined time limits, if the market bid and/or offer price are moving in a direction that makes future execution of the limit order unlikely, or the limit order or market conditions satisfies a user defined or system defined set of criteria.

If the router 116 determines that one or more of the limit orders are stagnant, the router 116 may determine if execution, in whole or in part, of the electronic trade order is possible via a different electronic trading venue, such as ATS 110. This determination is based on, at least, the original price stored in database 106 and information received by the smart server 118 and router 116 from the market data feed 122.

In one embodiment of the present invention, the determination, by the router 116, if execution, in whole or in part, of the electronic trade order is possible via a different electronic trading venue, such as an ATS 110 is performed by determining, for a BUY order:
if there is an order in the ATS 110 that can execute against the original price stored in database 106, and
if the original price, stored in database 106, is equal to or more than the midpoint of the National Best Bid and Offer (NBBO), and the probable matching SELL order in the ATS 110 has a limit price equal to or less than the midpoint of the NBBO.

The reverse is true for a SELL original limit order and the matching BUY order in the ATS 110. Thus, for a SELL order, a possible match is present in the ATS 110 if:
there is an order in ATS 110 that can execute against the original price stored in database 106, and
the original price, stored in database 106, is equal to or less than the midpoint of the NBBO, and the probable matching BUY order in the ATS 110 has a limit price equal to or more than the midpoint of the NBBO.

If the router 116 determines that an execution of the electronic trade order is possible via an ATS 110, the router is configured to cancel the one or more limit orders and places an electronic trade order, which may be for any quantity of shares that is equal to or less than the remaining shares, at the ATS 110. If after the ATS order executes there are unexecuted shares, these remaining shares are returned to the router 116 for further routing to electronic trading venues (108, 112, 114) for execution, as described above.

According to another aspect of the present invention, electronic trade orders may be sent directly to the smart server 118 and router 116. The smart server 118 and router 116 may be configured to accept electronic trade orders having one or more limit prices. For example, an electronic trade order could have a first limit price to be used for orders sent to displayed electronic trading venues, and a second for orders sent to non-displayed electronic trading venues. The router 116 may be configured to execute the electronic trade order by dividing the electronic trade order into one or more limit orders, according to the electronic trade order and prevailing market conditions. The router 116 attempts to execute the one or more limit orders, as described in detail above. For example, when determining if execution of the electronic trade order is possible via a different electronic trading venue, such as ATS 110, the router 116 may utilize a limit price for use at non-displayed electronic trading venues that may or may not be the same as a second limit price for use at displayed electronic trading venues.

The embodiments of the present invention, as described above, may be implemented in an automatic fashion that is without explicit action by the user. One way this might be implemented is through the use of defaults. For example, when a user sends an order using their OMS, EMS, algorithmic trading system, etc. to the smart server 118 for routing, it is contemplated that a user may have previously set a default to use the current invention if the order remains stagnant.

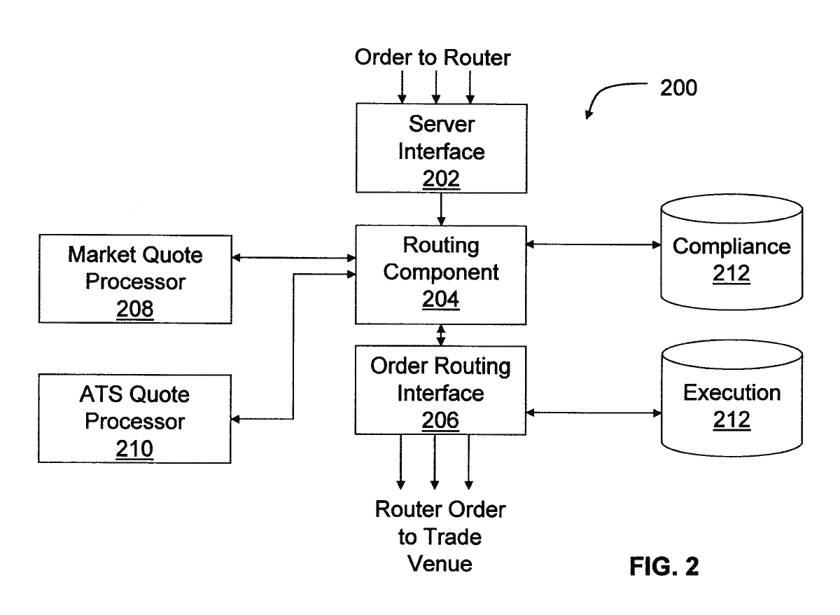

FIG. 2 is a block diagram of an exemplary router system, according to aspects of the present invention. Referring to FIG. 2, system 200 includes a trade routing system that is configured to receive and route electronic trade orders (having at least one limit price) as described herein; further, it is contemplated that other router configurations would also be acceptable for implementing embodiments of the present invention. System 200 may include a server interface 202 for interfacing and communicating with at least one server. As shown in FIG. 1, and as described above, router 116 can be housed in smart server 118. Server interface 202 may provide the router 116 with a means to electronically communicate with the smart server 118. Server interface 202 may be configured to receive electronic trade (e.g., electronic market and limit orders) orders.

The routing component 204 may be configured to receive electronic data, e.g., electronic trade order data, limit order data (including at least one limit price), market data, etc., from the server interface 202. The routing component 204 may also be configured to store, process, and conduct analysis on the received data. One aspect of the analysis conducted by the routing component 204 is to ensure that legal duties are being complied with. To facilitate this analysis, the routing component may be in electronic communication with one or more compliance databases 212. For example, compliance database 212 might include data regarding compliance with regulation national market system (RegNMS).

The routing component 204 is in electronic communication with the market quote processor 208 and is configured to receive market quote data regarding a plurality of trade venues. The market quote processor 208 processes market data received from the market data feed 122 and communicates the relevant data to the routing component 204. This data is utilized by the routing component 204 in determining which of the electronic trading venue(s) orders should be routed to for execution. Based on this determination and the analysis performed by the routing component 204, the order routing interface 206 routes the orders for execution at one or more of the electronic trade venues (108, 110, 112, 114). The order routing interface 206 is also in electronic communication with an execution database 212. The execution database 212 stores information regarding the placement, e.g., venue, time, shares, side, symbol, etc., and execution, e.g., venue, time, fill amounts, side, symbol, etc., of the routed orders.

For each of the previously routed limit orders, the routing component 204 periodically, i.e., from time to time, continuously, or at an interval in between, determines if any of the limit orders are stagnant. This determination is facilitated by accessing the execution database 212 via the order routing interface 206. For example, the routing component 204 can determine that no execution has occurred if the fill amount for a limit order is 0. If no execution has occurred, a determination as to whether or not the limit order is stagnant may be made. This determination may be based upon the information contained in the execution database 212, as well as on the information received via the market data feed 122. For example, a limit order may be deemed stagnant is it has been outstanding for more than 12 hours and the best bid and offer prices are continuing to move away from a price at which the limit order could execute. As described above the criteria for making a determination that a limit order is stagnant may vary from user to user and system to system.

If one or more limit orders are deemed to be stagnant, the routing component 204 determines if execution, either whole or partial, of the electronic trade order is possible at an ATS, as described in detail below. In one aspect of making this determination, the routing component 204 receives data from the ATS quote processor 210. The ATS quote processor 210 processes ATS data received from the market data feed 122, which can include data concerning the current quotes in an ATS, and communicates the relevant data to the routing component 204. If the electronic trade order can be executed at an ATS, the routing component 204, via the order routing interface 206, cancels the one or more limit orders, associated with the electronic trade order, that were previously placed at the electronic trade venues (108, 112, 114). Once the limit orders have been cancelled, an ATS order is generated at the routing component 204 and routed via the order routing interface 206 to the ATS for execution. The ATS order can be for any quantity of shares that is less than or equal to the currently outstanding share amount of the electronic trade order. If the ATS order is only partially executed, the unexecuted portion of the ATS order is cancelled by the routing component 204, via the order routing interface 206, and the remaining shares are routed to electronic trading venues, via the market quote processor 208, as described above.

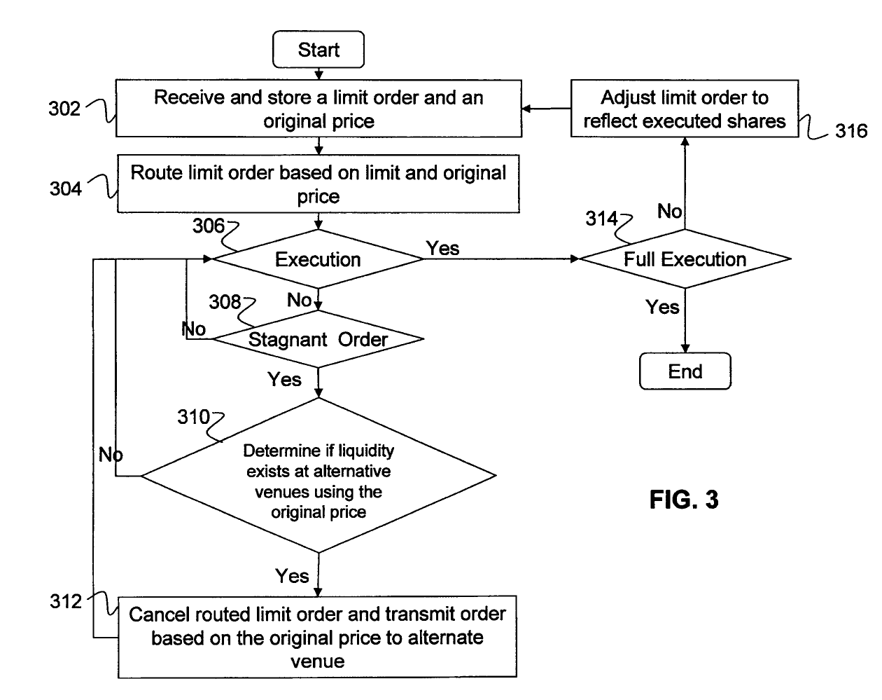

FIG. 3 is a flow diagram of an exemplary routing process, according to one or more embodiments of the present invention. Referring to FIG. 3, at step 302, a router, such as the smart routers described above, receives and stores a limit order and at least on original price (it is contemplated that a limit order can have multiple limit prices) if the limit order originated form another source, such as an algorithmic trade system. The limit order and at least one original price may be received from a variety of sources including, but not limited to an algorithmic trading system. The limit order and at least one original price may be stored in a database, such as an order database.

At step 304, the router routes the limit order for execution to an electronic trade venue based on market conditions as already described. At step 306, the router determines whether or not the placed limit order has been executed, as described above. If the placed limit order has been executed, at step 314 the router determines whether or not there are remaining shares to be executed. If there are no remaining shares to be executed the system ends. However, if there are remaining shares to be executed, step 316 adjusts the limit order to reflect the new quantity of remaining shares, i.e., total shares—executed shares. This updated limit order is then cycled through system beginning at step 302.

If at step 306, the router determines that there has not been an execution of the limit order, a determination is made at step 308 as to whether or not the limit order is stagnant, as described above. If it is determined that the limit order is not stagnant, the system rechecks the execution status at step 306. On the other hand, if the limit order is determined to be stagnant, the system determines if liquidity exists at an alternative trading venue, e.g., an ATS. This determination is made using the original price (if there is more than one original limit price associated with the first, original trade order, the limit price used in this determination is the limit price to be used at non-displayed electronic trading venues), received at step 302, and the data received via the market data feed, as shown in FIG. 1 and described above.

According to an embodiment of the present invention, step 310 is performed by determining, for a BUY order:
if there is an order in the ATS that can execute against the original price received at step 302, and
if the original price, received at step 302, is equal to or more than the midpoint of the NBBO, and the probable matching SELL order in the ATS has a limit price equal to or less than the midpoint of the NBBO.

The reverse is true for a SELL original limit order and the matching BUY order in the ATS. Thus, for a SELL order, a possible match is present in the ATS if:
there is an order in ATS that can execute against the original price received at step 302, and
the original price, received at step 302, is equal to or less than the midpoint of the NBBO, and the probable matching BUY order in the ATS has a limit price equal to or more than the midpoint of the NBBO.

If no liquidity is present at an alternative trading venue, then the system continues by monitoring the execution of the still outstanding limit order at step 306. Additionally, the system may be customized to cancel the outstanding order. If, on the other hand, at step 310 liquidity is found at an alternative trading venue at step, the system, at step 312 cancels the outstanding limit orders and transmits a new order, e.g., an ATS order as described above, based on the original price (if there is more than one original price associated with the original trade order, the limit price used is the one designated for use at non-displayed electronic trading venues) to the alternative venue, e.g., an ATS. Next the system continues at step 306, as described above.

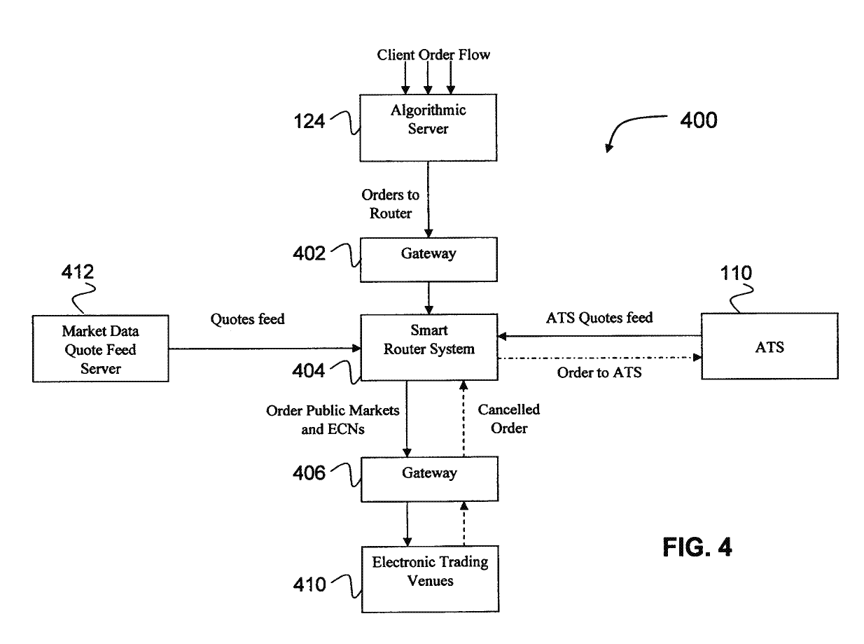

FIG. 4 is a block diagram of an exemplary electronic trade order router system. The system of FIG. 4 has components in common with the system shown in FIG. 1. Where these common components have been fully described with reference to FIG. 1, no additional description will be provided. Further, the components of FIG. 4 are utilized to perform the various embodiments of the present invention, as discussed above.

Referring now to FIG. 4, client order flow is received at the algorithm server 124, as described in detail above. The algorithmic server 124 generates one or more limit orders based on the received client order flow, as described above. The algorithmic server 124 then sends the one or more limit orders to the smart router system 404 via the gateway 402. The smart router system, as described with reference to FIGS. 1 (the combination of smart server 118 and router 116), 2, and 3, routes the received one or more limit orders, via the gateway 406, to the best possible public electronic trading venues 410 (shown in FIG. 1 as 108, 112, and 114) for execution. The gateways 402 and 406 can be configured to perform a various function including, but not limited to: reformatting and translation of data, enforcing security protocols, generating messages based on date received or sent, etc.

The smart router system 404 utilizes, at least, the received order information and the quotes feed sent from the market data feed server 412 in sending the one or more limit orders to the electronic trading venues 410 (shown in FIG. 1 as 108, 112, and 114), as described above. The smart router system 404 is configured to employ embodiments of the invention, as described above, when making a determination as to whether or not the one or more limit orders placed at the electronic trading venues 410 are stagnant. Additionally, as described above, the smart router system is configured to determine if liquidity for the received client order is present at ATS 110. This determination is based, at least in part, on an ATS quotes feed. If the smart routing system determines that liquidity for the received client order is present at ATS 110, the smart router cancels the one or more placed limit orders, and places a new order at ATS 110, as described above.

Various embodiments of the current invention could be implemented using a combination of both hardware and software components. For example, embodiments of the current invention could be implemented using, but not limited to, a Hewlett Packard System (Model ProLiant BL460c G1) with an Intel Xeon e5450 8 core 3 Ghz CPU or any x64-based or x86-based CPU (or equivalent AMD CPU), 8 GB RAM, 500 GB HDD, 4 Network Interface cards of 1 GB capacity, a graphic card, Input/Output devices (e.g. mouse, keyboard, monitor), and external storage devices (e.g. network storage, USB), running Microsoft Corporation Windows NT Server, Windows 2000 Server, Windows 2003 Server or Red hat Linux as an operating system as well as a Database System (e.g. MS SQL Server 2000, MS SQL Server 2008, Sybase ASE, Oracle 11 g, MySQL).

One of ordinary skill in the art will readily understand that the system can be based on architectures such as the Internet, an intranet, a client server, a centralized server, distributed servers, etc. The invention being thus described, it will be apparent to those skilled in the art that the same may be varied in many ways without departing from the spirit and scope of the invention. Any and all such modifications are intended to be included within the scope of the invention.

We claim:

1. A computerized method for smart order routing, said computerized method comprising the steps of:
receiving, by an electronic trading server, electronic order information defining a first electronic trade order including an identification of assets to trade on an electronic exchange or marketplace, a side of the first electronic trade order, and at least one limit price for the first electronic trade order;
storing, by the electronic trading server, the electronic order information in an electronic data storage facility;
according to a trading strategy, generating, by the electronic trading server, one or more second electronic trade orders based on the first electronic trade order;
transmitting, via an electronic trade router, the one or more second electronic trade orders to one or more electronic trading venues;
receiving, by the electronic trading server, market data from a non-displayed electronic trading venue;
determining, by the electronic trading server, if one or more of said second electronic trade orders has become stagnant;
if any of said second electronic trade orders are determined to be stagnant, electronically cancelling the second electronic trade orders that were determined to be stagnant, generating, by the electronic trading server, one or more third electronic trade orders based on the first electronic trade order and on the cancelled second electronic trade orders, and transmitting the third electronic trade orders to the non-displayed electronic trading venue.

2. The computerized method of claim 1, wherein the trading strategy generates and transmits the one or more second electronic trading orders based on the electronic information stored in the electronic data storage facility and on prevailing market conditions.

3. The computerized method of claim 1, wherein the one or more third electronic trade orders are generated further based on said market data of said non-displayed electronic trading venue.

4. The computerized method of claim 1, wherein the determining step is performed periodically.

5. The computerized method of claim 1, wherein the determining step comprises determining that the second electronic trade order has not executed.

6. The computerized method of claim 1, wherein the determining step comprises determining that a time period during which the second electronic trade order has not executed satisfies a stagnant order time setting.

7. The computerized method of claim 1, wherein the determining step comprises determining that future execution of the second electronic trade order is unlikely.

8. The computerized method of claim 1, wherein the determining step comprises determining that market price is moving away from the limit price of the second electronic trade order.

9. The computerized method of claim 1, further comprising a step of determining that a contra-order to the first electronic trade order exists in the non-displayed electronic trading venue.

10. The computerized method of claim 9, wherein the step of determining that a contra-order exists comprises:
determining that a contra-order to the first electronic trade order exists in the non-displayed electronic trading venue if the side of said first electronic trade order is buy, when said contra-order is a sell order having a limit price equal to or less than the midpoint of the NBBO and said at least one limit price is equal to or greater than the midpoint of the NBBO, and if the side of said first electronic trade order is sell, said contra-order is a buy order having a limit price equal to or greater than the midpoint of the NBBO and at least one limit price is equal to or less than the midpoint of the NBBO.

11. The computerized method of claim 9, wherein the step of determining that a contra-order exists comprises:
determining that a contra-order to the first electronic trade order exists in the non-displayed electronic trading venue if the side of said first electronic trade order is buy, when said contra-order is a sell order and said at least one limit price of the first electronic trade order is equal to or greater than the price of the contra-order, and if the side of said first electronic trade order is sell, said contra-order is a buy order and at least one limit price of the first electronic trade order is equal to or less than the price of the contra-order.

12. The computerized method of claim 1, wherein the first electronic trade order is an algorithmic trade order.

13. The computerized method of claim 1, wherein the trading strategy is an algorithmic trading strategy.

14. A system for smart routing of electronic trade orders, said system comprising:
an electronic trading server coupled with an electronic data network and configured to receive electronic order information defining a first electronic trade order;
to store the electronic order information in an electronic data storage facility, to generate, according to a trading strategy, one or more second electronic trade orders based on the first electronic trade order, to transmit, via an electronic trade router, the one or more second electronic trade orders to one or more electronic trading venues, to receive market data from a non-displayed electronic trading venue, to determine if one or more of said second electronic trade orders has become stagnant, and if any of said second electronic trade orders are determined to be stagnant, to electronically cancel the second electronic trade orders that were determined to be stagnant, to generate one or more third electronic trade orders based on the first electronic trade order and on the cancelled second electronic trade orders, and to transmit the one or more third electronic trade orders to the non-displayed electronic trading venue;
wherein the electronic order information includes an identification of assets to trade on an electronic exchange or marketplace, a side of the first electronic trade order, and at least one limit price for the first electronic trade order.

15. The system of claim 14, wherein the electronic trading server is further configured to generate and transmit the second electronic trade orders based on the electronic information stored in the electronic data storage facility and on prevailing market conditions.

16. The system of claim 14, wherein the second electronic trade orders are generated further based on said market data of said non-displayed electronic trading venue.

17. The system of claim 14, wherein the electronic trading server is configured to periodically determine if one or more of said second electronic trade orders has become stagnant.

18. The system of claim 14, wherein the electronic trading server is further configured to determine if one or more of said second electronic trade orders has become stagnant when the second electronic trade order has not executed after a predetermined period of time has elapsed.

19. The computerized method of claim 14, wherein the electronic trading server is further configured to determine if one or more of said second electronic trade orders has become stagnant when future execution of the second electronic trade order is unlikely.

20. The system of claim 14, wherein the electronic trading server is further configured to determine if one or more of said second electronic trade orders has become stagnant when the market price is moving away from the limit price of the second electronic trade order.

21. The system of claim 14, wherein the electronic trading server is further configured to determine that a contra-order to the first electronic trade order exists in the non-displayed electronic trading venue.

22. The system of claim 21, wherein the electronic trading server is further configured to determine that a contra-order to the first electronic trade order exists in the non-displayed electronic trading venue if the side of said first electronic trade order is buy, when said contra-order is a sell order having a limit price equal to or less than the midpoint of the NBBO and said at least one limit price is equal to or greater than the midpoint of the NBBO, and if the side of said first electronic trade order is sell, said contra-order is a buy order having a limit price equal to or greater than the midpoint of the NBBO and at least one limit price is equal to or less than the midpoint of the NBBO.

23. The system of claim 21, wherein the electronic trading server is further configured to determine that a contra-order to the first electronic trade order exists in the non-displayed electronic trading venue if the side of said first electronic trade order is buy, when said contra-order is a sell order and said at least one limit price of the first electronic trade order is equal to or greater than the price of the contra-order, and if the side of said first electronic trade order is sell, said contra-order is a buy order and at least one limit price of the first electronic trade order is equal to or less than the price of the contra-order.

24. The system of claim 14, wherein the original trade order is an algorithmic trade order.

25. The system of claim 14, wherein the trading strategy is an algorithmic trading strategy.

26. A computer recordable medium having executable computer instructions stored thereon for smart order routing, by performing operations comprising:
receiving, by an electronic trading server, electronic order information defining a first electronic trade order including an identification of assets to trade on an electronic exchange or marketplace, a side of the first electronic trade order, and at least one limit price for the first electronic trade order;
storing, by the electronic trading server, the electronic order information in an electronic data storage facility;
according to a trading strategy, generating, by the electronic trading server, one or more second electronic trade orders based on the first electronic trade order;
transmitting, via an electronic trade router, the one or more second electronic trade orders to one or more electronic trading venues;
receiving, by the electronic trading server, market data from a non-displayed electronic trading venue;
determining, by the electronic trading server, if one or more of said second electronic trade orders has become stagnant;
if any of said second electronic trade orders are determined to be stagnant, electronically canceling the second electronic trade orders that were determined to be stagnant, generating, by the electronic trading server, one or more third electronic trade orders based on the first electronic trade order and on the cancelled second electronic trade orders, and transmitting the third electronic trade orders to the non-displayed electronic trading venue.

27. The computer readable medium of claim 26, wherein the trading strategy generates and transmits the one or more second electronic trading orders based on the electronic information stored in the electronic data storage facility and on prevailing market conditions.

28. The computer readable medium of claim 26, wherein the one or more third electronic trade orders are generated further based on said market data of said non-displayed electronic trading venue.

29. The computer readable medium of claim 26, wherein the determining operation is performed periodically.

30. The computer readable medium of claim 26, wherein the determining operation comprises determining that the second electronic trade order has not executed.

31. The computer readable medium of claim 26, wherein the determining operation comprises determining that a time period during which the second electronic trade order has not executed satisfies a stagnant order time setting.

32. The computer readable medium of claim 26, wherein the determining operation comprises determining that future execution of the second electronic trade order is unlikely.

33. The computer readable medium of claim 26, wherein the determining operation comprises determining that market price is moving away from the limit price of the second electronic trade order.

34. The computer readable medium of claim 26, further comprising executable computer instructions stored for performing operations comprising determining that a contra-order to the first electronic trade order exists in the non-displayed electronic trading venue.

35. The computer readable medium of claim 34, wherein the operation that a contra-order exists comprises:
determining that a contra-order to the first electronic trade order exists in the non-displayed electronic trading venue if the side of said first electronic trade order is buy, when said contra-order is a sell order having a limit price equal to or less than the midpoint of the NBBO and said at least one limit price is equal to or greater than the midpoint of the NBBO, and if the side of said first electronic trade order is sell, said contra-order is a buy order having a limit price equal to or greater than the midpoint of the NBBO and at least one limit price is equal to or less than the midpoint of the NBBO.

36. The computer readable medium of claim 34, wherein the operation of determining that a contra-order exists comprises:
determining that a contra-order to the first electronic trade order exists in the non-displayed electronic trading venue if the side of said first electronic trade order is buy, when said contra-order is a sell order and said at least one limit price of the first electronic trade order is equal to or greater than the price of the contra-order, and if the side of said first electronic trade order is sell, said contra-order is a buy order and at least one limit price of the first electronic trade order is equal to or less than the price of the contra-order.

37. The computer readable medium of claim 26, wherein the first electronic trade order is an algorithmic trade order.

38. The computer readable medium of claim 26, wherein the trading strategy is an algorithmic trading strategy.
